(19) United States
(12) Patent Application Publication
(10) Pub. No.: US 2026/0285265 A1
(43) Pub. Date: Sep. 24, 2026

(54) ABS DEVICE FOR A HYDRAULIC BRAKING SYSTEM OF A CYCLE OR A MOTORCYCLE, PARTICULARLY FOR A BICYCLE

(71) Applicant: Blubrake S.p.A., Milano (IT)

(72) Inventors: Daniele BERRETTA, Milano (IT); Andrea VERZAGLIA, Milano (IT); Fabio TODESCHINI, Milano (IT)

(73) Assignee: Blubrake S.p.A., Milano (IT)

(21) Appl. No.: 19/490,131

(22) PCT Filed: Jul. 8, 2024
(86) PCT No.: PCT/IB2024/056617

§ 371 Date: Dec. 4, 2025

(30) Foreign Application Priority Data
Jul. 10, 2023 (IT) 102023000014319

(51) Int. Cl. B60T 8/17

(52) U.S. Cl. CPC B60T 8/1706

(57) ABSTRACT

An ABS device for a hydraulic braking system of a cycle or motorcycle includes an inlet connected to a master cylinder, an outlet, connected to an actuator cylinder associated with a brake device, a first hydraulic line connecting the inlet to the outlet, an electrically operated valve interposed in the first hydraulic line, a fluid accumulator and a second hydraulic line connecting an accumulation chamber of the fluid accumulator to the outlet. No electrically operated valve is interposed in the second hydraulic line. The fluid accumulator is an active accumulator, having a movable member positively controlled by an electric actuator when the ABS function is activated to cause a progressive and continuous, substantially linear, decrease of the pressure in the actuator cylinder, and when the ABS function is no longer required to cause a progressive and continuous, substantially linear, increase of the pressure in the actuator cylinder.

### FIELD OF THE INVENTION

The present invention relates to an ABS device for a hydraulic braking system of a cycle or a motorcycle, particularly (but not exclusively) for a hydraulic braking system of a bicycle, of the type comprising:
an inlet, to be hydraulically connected to a master cylinder associated with a brake lever,
an outlet, to be hydraulically connected to an actuator cylinder associated with a brake device,
a first hydraulic line connecting said inlet to said outlet,
an electrically operated valve, which is normally open, interposed in the first hydraulic line,
a fluid accumulator having an accumulation chamber defined by a movable member within a cavity, said movable member being normally in a starting position corresponding to a minimum volume of the accumulation chamber,
a second hydraulic line connecting the accumulation chamber to said outlet,
an electric actuator associated with the movable member of the fluid accumulator, and
an electronic controller configured to detect a condition in which an activation of an ABS function is required, and which, in said condition, is further configured to switch said electrically operated valve to a closed condition and to enable a movement of the movable member of the fluid accumulator so as to cause a decrease of the pressure in the second hydraulic line and a continuous modulation of said pressure,
wherein no electrically operated valve is interposed in said second hydraulic line between the fluid accumulator and said outlet.

### PRIOR ART

ABS devices specifically dedicated to hydraulic braking systems for bicycles, particularly bicycles with pedals assisted by a motor, have long been developed. The solutions proposed in the past are basically of two different types.

A first type of solution involves a first hydraulic line for the connection between the master cylinder associated with the brake lever and the actuator cylinder associated with the brake device (typically a disc brake caliper), and a second hydraulic line for the connection of the actuator cylinder of the brake device with the accumulation chamber of a passive-type fluid accumulator, having a movable member that can move against the action of a spring due to the effect of the pressurized fluid entering the accumulator. An electrically actuated, normally open, valve is interposed in the first hydraulic line to enable a flow of fluid from the master cylinder, associated with the brake lever, to the actuator cylinder, associated with the brake device, during normal braking. The second hydraulic line also includes an electrically operated valve that is normally closed, so as to isolate the fluid accumulator from the actuating cylinder of the brake device.

A condition in which activation of the ABS function is required is normally detected by means of a sensor configured to detect a decrease in the rotational speed of the wheel with which the brake device is associated (typically the front wheel of the bicycle), indicative of incipient locking of that wheel. Alternatively, the need to activate the ABS function is detected by checking when the rear wheel of the bicycle tends to come off the ground by monitoring the load acting on the rear wheel axle of the bicycle. Another way to detect the need for ABS function intervention is by directly monitoring the pressure applied to the actuator cylinder of the brake device.

When the ABS function needs to be activated, in known solutions of this first type an electronic controller causes the electrically operated valve interposed in the first hydraulic line to close, so as to isolate the master cylinder, associated with the brake lever, from the actuator cylinder, associated with the brake device, and at the same time the electrically operated valve interposed in the second hydraulic line is caused to open, so as to enable the flow of fluid from the actuator cylinder of the brake device to the fluid accumulation chamber of the fluid accumulator.

An example of an ABS device of this first type is described and shown in DE 19508915 A1. Further examples of ABS devices of this type are described in DE 101 58 382 A1, EP 2 943 395 B1, WO 2017/115171 A2, WO2019/159029 A1, EP 3 753 835 B1, and (EP 3 789 256 B1.

Still with reference to the known art, a second type of solutions involves a single hydraulic line for connection between the master cylinder associated with the brake lever and the actuator cylinder associated with the brake device and an ABS device interposed in this hydraulic line and basically constituting an active-type fluid accumulator, in which the displacement of the movable member of the accumulator in both directions is positively controlled by an electric motor. The accumulator chamber of such a device is permanently in communication with the downstream section of the hydraulic line, which is connected to the actuating cylinder of the brake device. At the same time, the accumulator chamber of the device is also connected with the upstream section of the hydraulic line, communicating with the master cylinder associated with the brake lever, with the interposition of a one-way valve comprising an on/off element elastically biassed to a closed position in such a way as to enable a flow of fluid only from said downstream section of the hydraulic line to said upstream section. The movable member of the fluid accumulator is configured to engage the on/off element of this one-way valve to hold the same in an open condition when the movable member of the device is in its starting position.

In devices of this second type, during normal braking, fluid flows from the master cylinder associated with the brake lever up to the actuator cylinder associated with the brake device flowing through the accumulation chamber of the device, since the one-way valve is kept open by the movable member of the device, which is in its starting position. When the need to activate an ABS function is detected (in one of the ways that have been described above), the electric motor that controls the movable member controls a movement of the movable member away from its starting position, so as to cause the one-way valve to close and the volume of the accumulation chamber to increase, which results in a decrease in pressure in the actuating cylinder of the brake device with a consequent decrease or cancellation of the braking action.

An example of a solution of this second type is described in EP 3 789 256 B1. Further examples of such solutions are described in EP2985198B1, U.S. Pat. No. 4,275,934A, and US 2020/324752 A1. The Applicant itself has developed solutions of this type, which have been described in documents EP4132841B1 and EP4132821B1.

All of the above known solutions are effective in avoiding the risk of wheel locking as a result of a loss of grip between the wheel and the ground during braking. However, there is a need for further improvements in this field in several respects.

A first need is to make an ABS device that is as simple in construction, light in weight, and of low cost.

A further important necessity is to ensure a reliable operation of the device under all operating conditions, guaranteeing safety for the user at all times even in the event of failure of the ABS device, ensuring in particular the full operation of the braking system even when the ABS device is failing or in the event that there is a depletion of the charge of the electric power supply battery with which the vehicle is equipped, or, more generally, in a condition in which, for whatever reason, the power supply to the ABS device fails.

Still another important need is to reduce as much as possible the energy required to activate the ABS device.

An ABS device of the type shown at the beginning of this description (and in the preamble to claim 1) is described and illustrated in EP 2 985 198 B1. Similar solutions are known from US 2018/009423 A1 and US 2006/138859 A1.

### OBJECT OF THE INVENTION

The main purpose of the present invention is to effectively solve all of the above mentioned problems.

More specifically, a first purpose of the invention is to provide an ABS device that is efficient in operation, of simple construction, and of low cost.

A further purpose of the invention is to provide an ABS device that ensures full safety for the user under all operating conditions, and proper operation of the braking system even when the ABS device fails or has no power supply.

A further purpose of the invention is to provide an ABS device that results in minimal power consumption for activating the ABS function.

### SUMMARY OF THE INVENTION

With a view to achieving one or more of the above-mentioned purposes, the invention provides an ABS device having the features which have been indicated at the beginning of this description and further characterized in that the electronic controller and the electric actuator of the movable member of the fluid accumulator are configured in such a way that:
when the ABS function is activated, the electronic controller controls, through the electric actuator, a displacement of the movable member, so as to cause a progressive and continuous, substantially linear, decrease of the pressure in the second hydraulic line which in use communicates with the actuator cylinder of the brake device,
when the ABS function is no longer required, the return of the movable member of the fluid accumulator to its starting position is anyway positively controlled by the electronic controller, through said electric actuator, in such a way as to cause a progressive and continuous, substantially linear, increase of the pressure in the second hydraulic line which in use communicates with the actuator cylinder of the brake device.

As a result of the above features, the ABS device according to the invention is able to optimally control both the decrease in pressure in the actuator cylinder of the brake device when the ABS function is activated, and the return of the pressure in said actuator cylinder to a higher level when the ABS function is no longer required, depending on the specific operating conditions during and after a braking action, which can be detected by the electronic controller by means of one or more sensors with which the vehicle is equipped, in a manner known per se.

Thus, the ABS device according to the invention provides more precise and reliable control of the braking operation both with respect to the known devices of the type using a passive fluid accumulator, in which the movable member is moved solely by the pressure of the fluid entering the accumulator, and with respect to known devices of the type illustrated in EP 2 985 198 B1, in which the movable member is moved away from its starting position by an electric actuator and then quickly returns to the starting position when the electric actuator is deactivated, due to the action of a return spring.

In a first embodiment, the ABS device according to the invention is characterized in that:
said electric actuator is an electric motor operatively connected to the movable member of the fluid accumulator by means of a mechanical transmission and configured to control a movement of the movable member either in a first direction corresponding to an increase in the volume of the accumulation chamber or in an opposite second direction corresponding to a decrease in the volume of the accumulation chamber, and
said electronic controller is configured for:
positively controlling, through said electric motor, a movement of the movable member of the fluid accumulator in said first direction, when a condition is detected in which an ABS function is required, so as to cause said progressive and continuous, substantially linear, decrease of the pressure in the second hydraulic line, and for
positively controlling, through said electric motor, a movement of the movable member of the fluid accumulator in said second direction, when the ABS function is no longer required, so as to cause said progressive and continuous, substantially linear, increase of the pressure in the second hydraulic line.

In a second embodiment, the electric actuator associated with the movable member of the fluid accumulator is a solenoid configured to push the movable member towards its starting position, thus counteracting a force generated by a hydraulic pressure tending to move the movable member in the direction of an increase in the volume of the accumulation chamber,
said electronic controller being configured to control the solenoid such that:
if the user starts braking, the solenoid is activated to keep the movable member of the accumulator in the position in which the accumulation chamber has a minimum volume,
when the ABS function is required, the force generated by the solenoid is progressively reduced, by reducing the current supplied to the solenoid, so that the movable member tends to move and create an increasing volume in the accumulator chamber in a progressive, substantially linear, manner, so as to cause said progressive and continuous, substantially linear, decrease of the pressure in the second hydraulic line, and
when the ABS function is no longer required, the force generated by the solenoid is progressively increased, by increasing the current supplied to the solenoid, in such a way as to cause said progressive and continuous, substantially linear, increase of the pressure in the second hydraulic line.

During normal braking, the electrically operated valve interposed in the first hydraulic line is open, so that the pressurized fluid from the master cylinder can reach up to the actuating cylinder of the brake device. Under such a condition, the movable member of the fluid accumulator is in its starting position, corresponding to the minimum volume of the accumulation chamber.

Preferably, the fluid accumulator has no spring to pull the movable member back to its starting position.

In the first embodiment, in the case where the mechanical transmission between the electric motor and the movable member is of an irreversible type, the movable member is kept in its starting position while leaving the electric motor to idle. In the case where the mechanical transmission is of the reversible type, the electric motor is activated in such a way as to keep the movable member in its starting position.

In the case of the first embodiment, when the need to activate the ABS function is detected in any known way, the electronic controller causes the electrically operated valve interposed along the first hydraulic line to close and activates the electric motor of the fluid accumulator to positively cause a displacement of the movable member of the fluid accumulator that results in an increase in the volume of the accumulation chamber. This accumulator chamber is always in communication via the second hydraulic line with the actuator cylinder of the brake device, so its increase in volume causes a decrease in pressure in the actuator cylinder of the brake device.

During the activation of the ABS function, the electric motor is controlled by the electronic controller on the basis of the signal from a pressure sensor in the second hydraulic line communicating with the actuating cylinder of the brake device, and, if necessary, also on the basis of a position control of the movable member of the fluid accumulator, with the help of a position sensor associated with the movable member.

In a first example, the second hydraulic line has both a downstream portion, connecting the accumulator chamber with said outlet of the ABS device, and an upstream portion, connecting the accumulator chamber with said inlet of the ABS device, with the interposition of a one-way valve comprising an on/off element elastically biassed to a closed position, so as to allow a flow of fluid only from said downstream portion to said upstream portion.

In such an example, preferably the movable member of the fluid accumulator is configured to hold the on/off element of said one-way valve in an open condition when the movable member is in its starting position.

In a further example, the movable member is configured so that it never interacts with the on/off element of the one-way valve, so that said on/off element opens only when the inlet-side pressure falls below the outlet-side pressure to an extent sufficient to overcome the spring action tending to keep the on/off element closed. Thus, when the user ceases to operate the brake lever subsequent to the intervention of the ABS function, the decrease in pressure on the upstream side of the second hydraulic line allows the fluid to return to the master cylinder.

In a further, simplified example, the second hydraulic line includes only the aforementioned downstream portion that permanently keeps the accumulation chamber in communication with the ABS device outlet, while the aforementioned upstream portion that in the aforementioned first embodiment connects the accumulation chamber with the ABS device inlet is eliminated. Consequently, in this example, the one-way valve associated with the fluid accumulator is not even provided to control the communication between the accumulation chamber and the inlet of the ABS device.

In this further example, during normal braking, fluid flows from the master cylinder to the actuator cylinder of the brake device through the first hydraulic line and through the electrically operated valve that is in an open condition. In this condition, the movable member of the fluid accumulator is maintained in its starting position. When the ABS function is required, the electrically operated valve is closed, while the electric motor drives a movement of the movable member of the fluid accumulator that causes an increase in the volume of the fluid chamber and a consequent decrease in the pressure in the second hydraulic line communicating with the actuating cylinder of the brake device. When the user ceases to operate the brake lever subsequent to the intervention of the ABS function, this condition is detected by a pressure sensor interposed in the first hydraulic line, between the master cylinder and the electrically operated valve. As a result, the controller causes the electrically operated valve to open so that fluid can return from the brake actuator cylinder back to the master cylinder. Alternatively, a one-way valve is provided in the first hydraulic line, integrated into the electrically operated valve, so that when the electrically operated valve is closed, said one-way valve still allows a flow of fluid in the inlet direction, through the electrically operated valve, if the pressure at the inlet falls below the pressure at the outlet by a differential greater than a threshold.

In one actual example of the aforementioned first embodiment, the mechanical transmission interposed between the electric motor and the movable member of the fluid accumulator is a gear transmission that connects an outlet shaft of the electric motor with a rack rigidly connected to the movable member.

In one actual example of construction, the electrically operated valve and the fluid accumulator are arranged within the same body, in which said inlet, said outlet, said first hydraulic line and said second hydraulic line are also formed.

In this example, the first hydraulic line includes:
a first elongated cavity formed in said body from said inlet,
a second elongated cavity formed in said body, and intersecting the first cavity in a direction orthogonal to the direction of said first cavity, and
a third elongated cavity formed in said body, intersecting said second cavity, in a direction parallel to and spaced apart from the direction of the first cavity, and terminating in said outlet;

the electrically operated valve has a movable stem within said second cavity between an open position, in which the first cavity communicates with the third cavity by means of a passage defined between the movable stem and the wall of the second cavity, and a closed position, in which a sealing ring, surrounding said stem, engages a valve seat formed in said wall of the second cavity so as to obstruct said passage.

Also, in the case of this example, said second hydraulic line includes a fourth elongated cavity formed in said body in a direction parallel to and spaced apart from the direction of said second cavity and flowing into said third cavity, and said accumulation chamber is defined by a fifth elongated cavity, orthogonal to said fourth cavity and flowing into said fourth cavity, said movable member being a sliding stem in said fifth cavity.

As is clearly apparent from the foregoing description, the ABS device according to the invention, in its various embodiments, ensures proper and reliable operation under all operating conditions, is relatively simple and of low cost, and still ensures full operation of the braking system in the event of failure of the ABS device or lack of power supply. In addition, the device is configured to involve minimal energy consumption when the ABS function needs to be activated.

The invention also relates to the method of controlling a brake device implemented via the ABS device described above.

### DETAILED DESCRIPTION OF THE INVENTION

Further features and advantages of the invention will result from the following description with reference to the appended drawings, provided purely by way of non-limiting examples, in which:

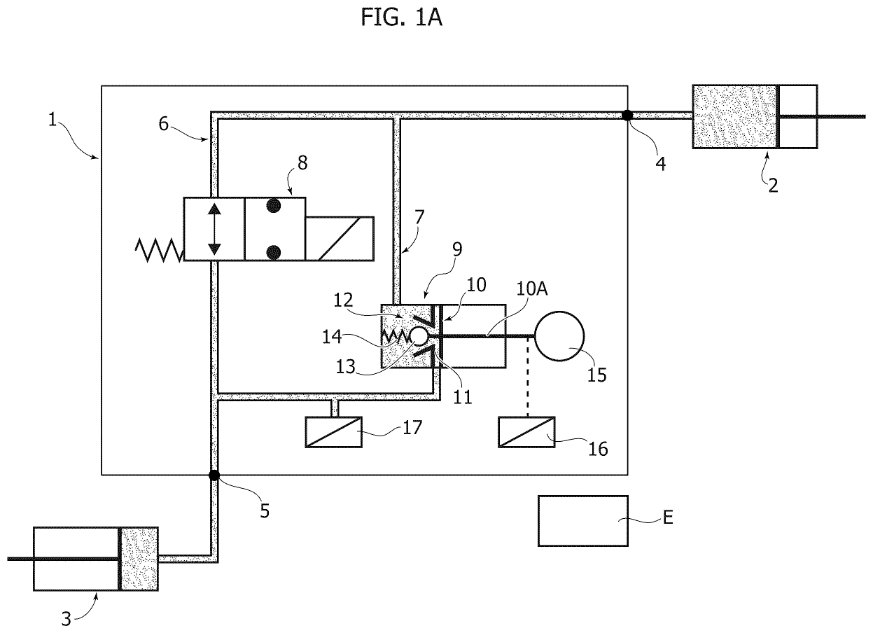

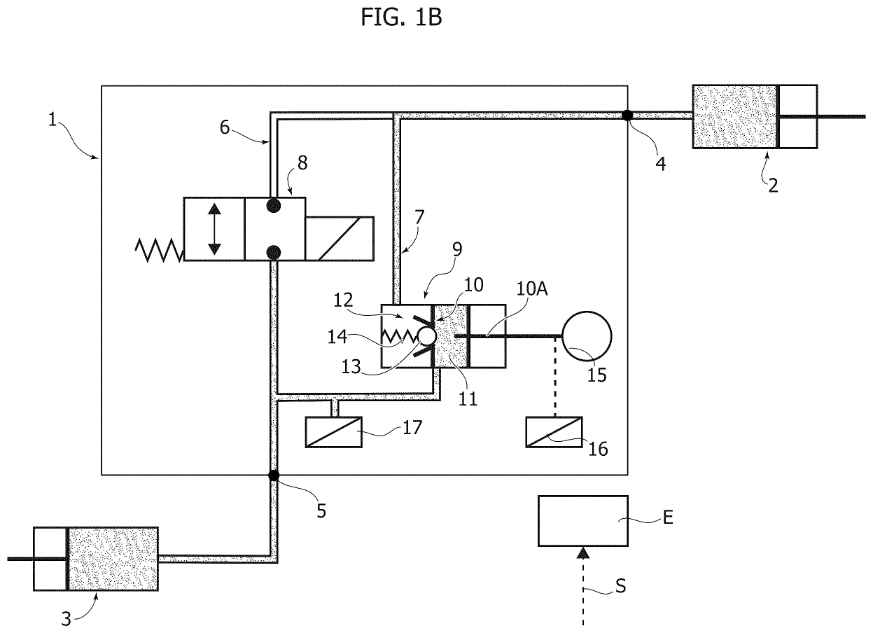

FIGS. 1A, 1B are diagrams illustrating two different operating conditions of a first embodiment of the ABS device according to the invention,

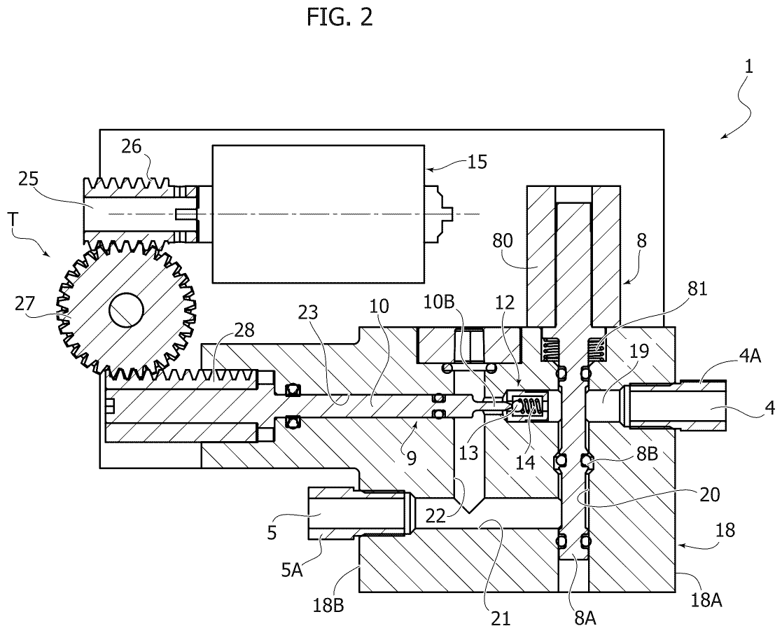

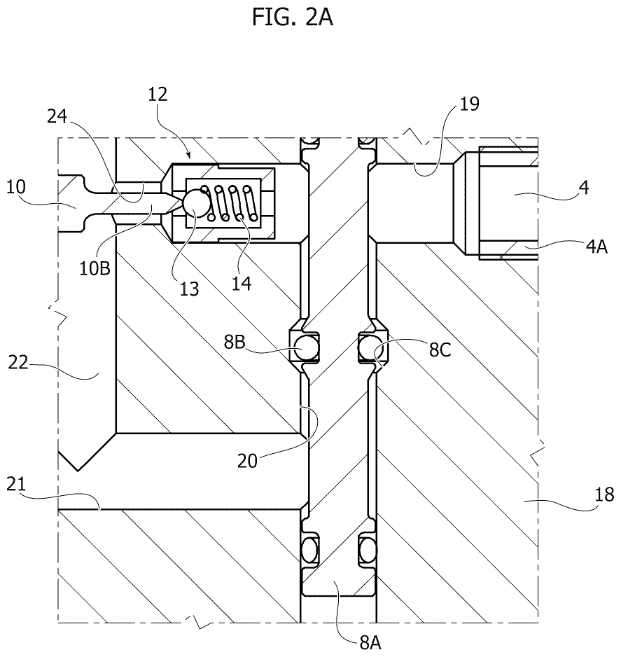

FIG. 2 is a cross-sectional view of an example of construction of the first embodiment, in a first operating condition,

FIG. 2A shows a detail of FIG. 2 at an enlarged scale,

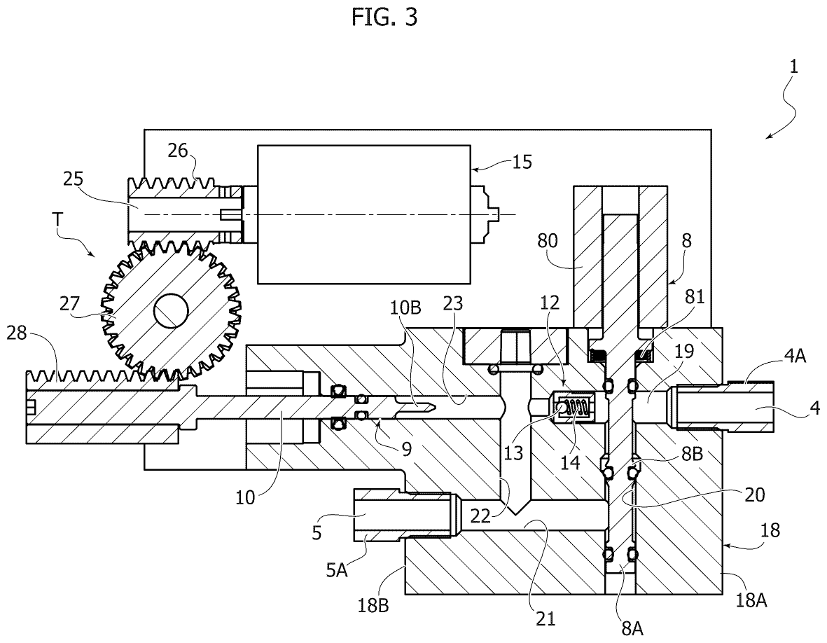

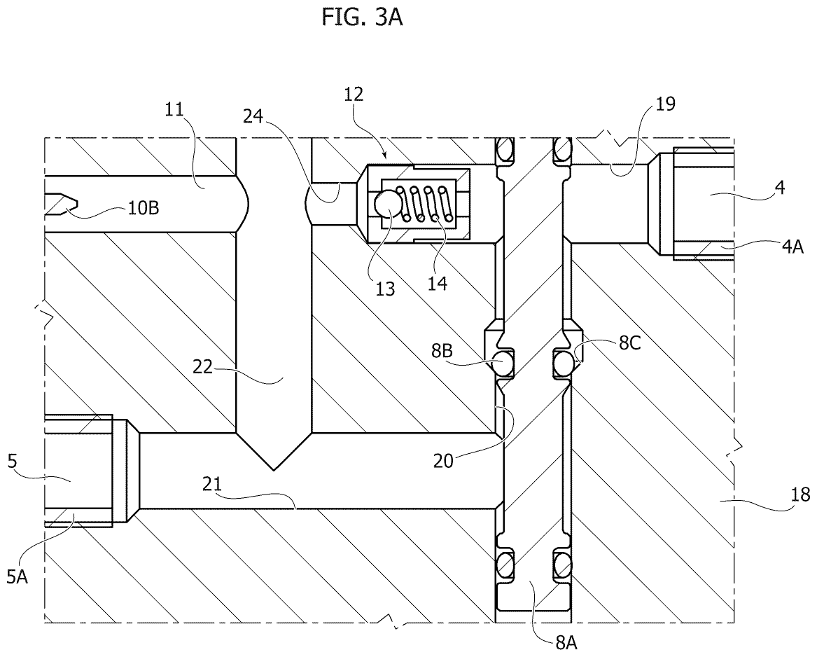

FIG. 3 shows the same cross-sectional view as FIG. 2, in a second operating condition,

FIG. 3A illustrates a detail of FIG. 3 at an enlarged scale,

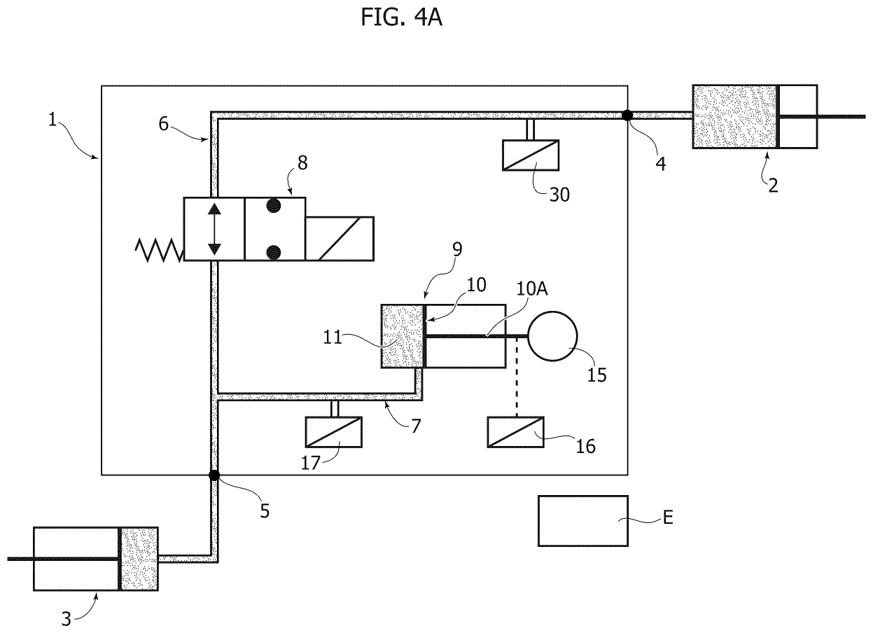

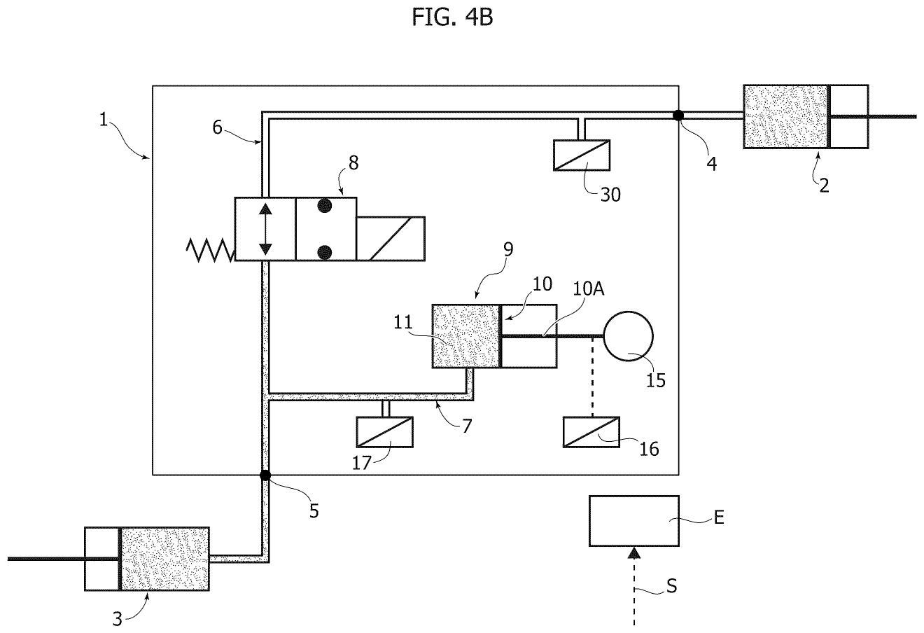

FIGS. 4A, 4B are diagrams illustrating two different operating conditions of a second embodiment of the ABS device according to the invention, and

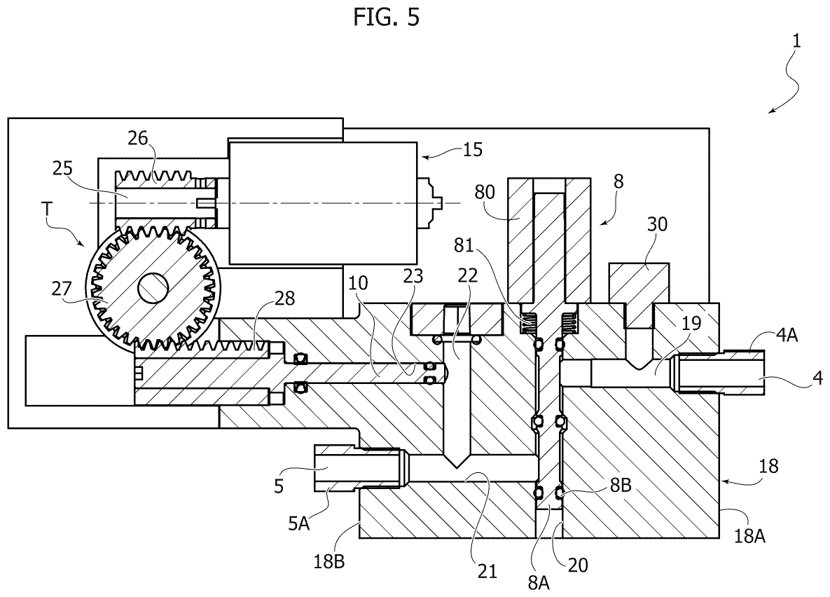

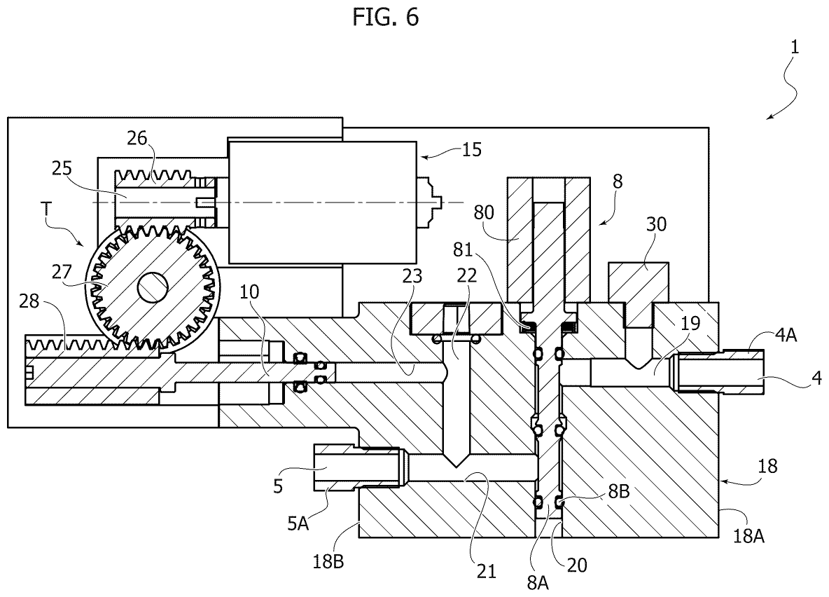

FIGS. 5 and 6 are cross-sectional views of an example of construction of the second embodiment, in two different operating conditions.

In the drawings, reference number 1 generally indicates an ABS device for a hydraulic braking system of a bicycle, such as a bicycle with motor-assisted pedals.

FIGS. 1A, 1B show a diagram of a first embodiment of the device in a normal operating condition of the braking system, with the ABS function deactivated, and in an activated condition of the ABS function, respectively.

In the diagrams in FIGS. 1A, 1B, the ABS device 1 is illustrated as a part of the hydraulic braking system of the bicycle, which includes a master cylinder 2 that is associated, in any known manner, with a brake actuation lever, and an actuator cylinder 3 associated, in any known manner, with a brake device, typically a disc brake caliper associated with the front wheel of the bicycle.

Referring to FIGS. 1A, 1B, ABS device 1 includes an inlet 4, hydraulically connected to master cylinder 2, and an outlet 5, hydraulically connected to actuator cylinder 3 of the brake caliper.

In the embodiment shown in FIGS. 1A, 1B, inlet 4 and outlet 5 communicate with each other either through a first hydraulic line 6 or through a second hydraulic line 7.

An electrically operated valve 8 is interposed in the first hydraulic line 6. In the example, the electrically operated valve 8 is a normally open solenoid valve whose solenoid can be activated to switch it to a closed condition.

Also, in the case of the first embodiment illustrated in FIGS. 1A, 1B, a fluid accumulator 9 including a movable member 10 defining an accumulation chamber 11 is interposed in the second hydraulic line 7. In FIG. 1A, the movable member 10 is illustrated in its starting position (the leftward end position, with reference to FIG. 1) in which the accumulation chamber 11 has a minimum volume, while in FIG. 1B, the movable member 10 is illustrated in a position away from its starting position (toward the right, with reference to the figure) corresponding to an increase in volume of the accumulation chamber 11.

The accumulation chamber 11 of the fluid accumulator 9 permanently communicates with the portion of the second hydraulic line 7 that is arranged downstream of the fluid accumulator 9, between the fluid accumulator and the outlet 5 communicating with the actuator cylinder 3 of the brake caliper.

In addition, again with reference to the embodiment of FIGS. 1A, 1B, the accumulation chamber 11 can also communicate with the inlet 4 via the upstream portion of the second hydraulic line 7 that is arranged between the fluid accumulator 9 and the inlet 4 communicating with the master cylinder 2.

The communication between the accumulator chamber 11 and the upstream portion of the second hydraulic line 7 is controlled by a one-way valve 12 comprising a on/off element 13 recalled by a spring 14 to a closed position, so as to allow fluid flow only from the accumulator chamber 11 to the upstream portion of the second hydraulic line 7 connected to the inlet 4.

Still with reference to the embodiment in FIGS. 1A, 1B the movable member 10 of the fluid accumulator 9 is also configured, as will be better illustrated below, so that when it is in its starting position it engages the on/off element 13 and keeps it in an open condition, in which the upstream and downstream portions of the second hydraulic line 7 are in communication with each other.

In the diagrams in FIGS. 1A, 1B, the movable member 10 is illustrated in the form of a plunger, with a stem 10A. However, the conformation of the movable member can widely vary, as will also be seen below.

According to this embodiment, the ABS device includes an electric motor 15 configured to control, by means of a mechanical transmission (not illustrated in the schematic FIGS. 1A, 1B), the movement of the movable member 10 both in a first direction, corresponding to an increase in the volume of the accumulation chamber 11, and in a second direction, corresponding to a decrease in the volume of the accumulation chamber 11.

Associated with ABS device 1 is an electronic controller E, which controls electric motor 15 and electrically operated valve 8 and receives signals from a position sensor 16, configured to detect the position of mobile member 10, from a pressure sensor 17, configured to detect the pressure in the downstream portion of the second hydraulic line 7 communicating with outlet 5, and may additionally receive a signal S (FIG. 1B) from a sensor (not shown) associated with the vehicle, indicative of a condition in which activation of the ABS function is required. Typically, such a sensor may be a bicycle front wheel speed sensor, which can detect a tendency for the wheel to lock. Alternatively, the sensor may be associated with the rear wheel axle to detect a decrease in the load on the rear axle such that the rear wheel becomes detached from the ground.

The operation of the ABS device schematically shown in FIGS. 1A, 1B is as follows.

Normally, the solenoid valve 8 is in an open condition and the movable member 10 of the fluid accumulator 9 is in its starting position, corresponding to a minimum volume of the accumulation chamber 11. In case the mechanical transmission interposed between the electric motor 15 and the movable member 10 is an irreversible transmission, this condition is obtained by keeping the electric motor 15 idle, since with the electric motor idle the movable member 10 is locked in position. If, on the other hand, the mechanical transmission is a reversible type, the movable member 10 is maintained in its starting position by activating the electric motor 15 and controlling it so as to keep the movable member 10 in that starting position.

In this normal operating condition, the user can activate the brake device by acting on the brake lever. The action on the brake lever causes a displacement of the movable member of the master cylinder 2, which results in a passage of fluid from the master cylinder to the actuator cylinder 3 of the brake caliper, through the first hydraulic line 6 and the solenoid valve 8, which is in an open condition. In such a condition, fluid can also flow through the second hydraulic line 7 and through the accumulation chamber 11 of the fluid accumulator 9, as the one-way valve 13 is kept open by the movable member 10, the latter being in its starting position. The above operating condition is illustrated in FIG. 1A.

When the electronic controller E receives a signal S indicative of the need to activate the ABS function (FIG. 1B), the electronic controller E switches the solenoid valve 8 to the closed condition and activates the electric motor 15 to move the movable member 10 away from its starting position, resulting in an increase in the volume of the accumulation chamber 11.

When the movable member 10 moves away from its starting position, the one-way valve 13 closes so it interrupts the communication of the accumulation chamber 11 with the inlet 4. Therefore, when the ABS function is activated, master cylinder 2 is no longer in communication with the actuator cylinder of the brake device, either through the first hydraulic line 6, since solenoid valve 8 is closed, or through the second hydraulic line 7, since one-way valve 13 is closed. At the same time, the increase in volume of the accumulation chamber 11 results in a decrease in pressure at the outlet 5 of the ABS device, resulting in a decrease or cancellation of the braking action. At that stage, the electronic controller E controls the electric motor 15 based on the position signal of the movable member 10 from sensor 16 and based on the pressure signal from sensor 17.

As indicated in the foregoing, according to this embodiment, the electronic controller E positively controls, through the electric motor 15, a movement of the movable member 10 of the fluid accumulator 9 in said first direction, when a condition is detected in which an activation of an ABS function is required, so as to cause a progressive and continuous, substantially linear, decrease of the pressure in the second hydraulic line 7.

When the ABS function is no longer needed, the electronic controller E returns the solenoid valve 8 to the open condition to allow a return of fluid to the master cylinder 2, and the electric motor 15 controls a return of the movable member 10 to its starting position.

In this condition, the electronic controller E positively controls, through the electric motor 15, a movement of the movable member 10 of the fluid accumulator 9 in said second direction, so as to cause said progressive and continuous, substantially linear, increase of the pressure in the second hydraulic line 7.

If, due to a failure or lack of power supply, electric motor 15 is unable to return movable member 10 to its starting position, the proper operation of the braking system (without ABS function) is still ensured by the first hydraulic line 6, keeping solenoid valve 8 in its open condition.

FIGS. 2, 2A, 3, 3A show an example of construction of the first embodiment of the diagrams of FIGS. 1A, 1B, in the normal operating condition (FIGS. 2 and 2A) and in the condition with ABS function activated (FIGS. 3 and 3A), respectively.

In FIGS. 2, 2A, 3, 3A, the parts corresponding to those in FIGS. 1A, 1B are marked with the same references.

In this actual implementation, solenoid valve 8, fluid accumulator 9, first hydraulic line 6, second hydraulic line 7, inlet 4 and outlet 5 are all arranged in one supporting body 18.

In the case of this example, an elongated first cavity (in the example of cylindrical shape) is formed in the body 18 from an outer surface 18A of the body 18. The inlet 4 of the ABS device is defined by a tubular fitting 4A screwed into a threaded portion of the cavity 19. Also formed in body 18 is a second elongated cavity (in the example cylindrical in shape), denoted 20, which intersects the first cavity 19 in a direction orthogonal to the direction of cavity 19.

A third elongated cavity (in the cylindrically shaped example) indicated by 21 is also formed in body 18, intersecting the second cavity 20 and directed in a direction parallel to and spaced apart from the direction of the first cavity 19. The third cavity 21 flows onto a wall 18B on a side opposite the side of wall 18A and has a threaded end portion into which a fitting 5A defining outlet 5 is screwed.

In the example, the solenoid valve 8 has a movable stem 8A within the second cavity 20 between an open position (illustrated in FIGS. 2 and 2A) in which the first cavity 19 communicates with the third cavity 21 via a passage defined between the movable stem 8A and the wall of the second cavity 20, and a closed position, in which a sealing ring 8B (see FIG. 2A) carried by the movable stem 8A and surrounding the stem engages a valve seat 8C defined by the wall of the second cavity 20, so as to obstruct the said passage. The movement of stem 8A between its closed position and its open position is controlled by a solenoid 8. A spring normally tends to keep stem 8A in a raised position (FIGS. 2, 2A). A solenoid 80, when energized, causes stem 8A to be lowered to a position (shown in FIGS. 3 and 3A) where seal ring 8B engages valve seat 8C.

Hydraulic line 6 in FIGS. 1A, 1B is defined by inlet 4, cavity 19, the space between stem 8A and the wall of cavity 20, and cavity 21 flowing into outlet 5.

Naturally, the configuration of solenoid valve 8 could also be different from the one shown here as an example and make use of a on/off element having any configuration.

A fourth elongated cavity (in the example cylindrical in shape) indicated by 22 is also formed in the body 18, extending in a direction parallel to and spaced apart from the direction of the second cavity 20 and flowing into the third cavity 21. By way of example by way of example Accumulation chamber 11 is defined by an elongated fifth cavity (in the example cylindrical in shape), indicated by 23, orthogonal to and flowing into the fourth cavity 22.

The movable member 10 of the fluid accumulator 9 is a cylindrical rod sliding in the fifth cavity 23.

In the implementation of FIGS. 2, 2A, 3, 3A, the fifth cavity 23 is arranged aligned on the extension of the first cavity 19 on a side of the fourth cavity 22 opposite to the side of the first cavity 19, and the intersection zone between the fourth cavity 22 and the fifth cavity 23 communicates with the first cavity 19 via a communication passage 24 (FIGS. 2A and 3A).

At one end of the first cavity 19, on the opposite side from inlet 4, is arranged the one-way valve 12 suitable for allowing fluid flow only from cavity 22 to cavity 19.

The one-way valve 12 includes a on/off element 13 recalled by a spring 14 to a closed position that obstructs the communication passage 24.

In this embodiment, the movable member 10 has a front nose 10B that engages the on/off element 13 so as to keep it in its open position when the movable member 10 is in its home position (FIG. 2A).

The electric motor 15 that controls the position of movable member 10 is carried outside body 18. The motor 15 has an outlet shaft 25 directed parallel to the axis of the cavity 23 in which the movable member 10 is mounted sliding. A gearing screw 26 with a gear wheel 27 is mounted on the shaft 25. On the opposite side of the screw 26, the gear wheel 27 meshes with a cogwheel 28 rigidly connected to the movable member 10. The electric motor 15 is configured to be operable to rotate the shaft 25 in one direction or the opposite direction. Consequently, the mechanical transmission, denoted as a whole by T, which in this example consists of screw 26, wheel 27, and tine 28, controls a sliding of movable member 10 in one direction or the opposite direction. Of course, the mechanical transmission T could be of any other type.

As is evident from the above description, in the implementation example shown in FIGS. 2, 2A, 3, 3A, the first hydraulic line 6 in FIGS. 1A, 1B consists, as already indicated, of the succession of cavities 19, 20, 21, while the second hydraulic line 7 in FIGS. 1A, 1B has its upstream section (between the accumulator and the inlet) consisting of cavity 19, and its downstream section (between the accumulator and the outlet) consisting of cavity 22 and cavity 21.

FIGS. 2 and 2A show the movable member in its starting position (the end position to the right, with reference to the figures) in which the nose 10B keeps the one-way valve 12 open. From this position, an activation of the electric motor 15 commands a shift to the left (with reference to the figures) so as to result in an increase in the volume of the accumulator chamber 11 (FIGS. 3 and 3A).

In normal operation, the movable member is in the condition shown in FIGS. 2 and 2A in which the one-way valve 12 is closed and the solenoid valve 8 is open. When the user actuates the brake lever, pressurized fluid from the master cylinder enters inlet 4 and, via cavity 19, the space existing between the stem 8A and the wall of cavity 20 and cavity 21, reaches outlet 5 from which it can flow to the actuator cylinder of the brake device. In this condition, communication through the one-way valve 12 and cavity 22 is also open.

When the ABS function is activated (FIG. 2B), the electric motor moves the movable member 10 away from its starting position, while solenoid 80 is energized to move the stem 8A to its closed position. Under this condition, the communication of inlet 4 with outlet 5 is interrupted due to the closing of solenoid valve 8. At the same time, the increase in volume of accumulation chamber 11 results in a decrease in pressure at outlet 5 communicating with the actuator cylinder of the brake caliper, which results in a reduction or cancellation of the braking action.

If, under such a condition, the user ceases to operate the brake lever, it results in a decrease in pressure at inlet 4 that causes on/off element 13 of one-way valve 12 to open against the action of spring 14 that allows fluid to flow from outlet 5 to inlet 4.

FIGS. 4A, 4B illustrate a second embodiment that differs from the first embodiment in FIGS. 1A, 1B mainly in that in this case the second hydraulic line 7 includes only its downstream portion, which connects the accumulation chamber 11 of the fluid accumulator 9 with the outlet 5 communicating with the actuator cylinder of the brake device 3, and does not include the upstream portion that is provided in the case of the first embodiment. Consequently, the fluid accumulator 9 in this case is also not provided with the one-way valve 12 to control the communication between the accumulation chamber and the inlet 4 of the ABS device. A further difference is that in this case a pressure sensor 30 is provided in the portion of the first hydraulic line 6 communicating with inlet 4 and master cylinder 2. Alternatively, a one-way valve can be provided in the first hydraulic line, integrated into the electrically operated valve, so that when the electrically operated valve is closed, said one-way valve still allows a flow of fluid in the inlet direction, through the electrically operated valve, if the pressure at the inlet falls below the pressure at the outlet by a differential greater than a threshold.

In normal operation, solenoid valve 8 is open and moving device 10 is in its starting position corresponding to the minimum volume of the accumulation chamber (FIG. 4A). When the ABS function is activated, solenoid valve 8 is closed and movable member 10 is moved away from its starting position, via electric motor 15, so as to cause a pressure decrease at outlet 5 communicating with actuator cylinder 3 of the brake device.

If in such a condition the user ceases its action on the brake lever, the sensor 30 detects the consequent decrease in pressure so that the electronic controller E can cause the solenoid valve 8 to open to allow fluid to return to the master cylinder. The same occurs if, due to any failure or lack of power supply, the electric motor 15 is unable to return the movable member 10 to its starting position.

FIGS. 5, 6 illustrate a concrete example corresponding to the second embodiment in FIGS. 3A, 3B. Compared with the solution in FIGS. 2, 3, the solution in FIGS. 5, 6 has the difference that cavity 22 does not communicate with cavity 19 so that as a result the one-way valve 12 is also eliminated. FIGS. 5, 6 also illustrate the pressure sensor 30 arranged to detect the pressure at inlet 4.

In a further variant of the first embodiment illustrated in FIGS. 1A, 1B and 2, 3, the movable member 10 can be provided without the nose 10B, so that when the movable member 10 is in its starting position, the one-way valve 12 is still closed. Therefore, in this variant, during normal braking, fluid flows only through the first hydraulic line defined by cavities 19, 20, 21. During the activation of the ABS function, the movable member 10 moves away from its starting position creating the increase in volume of the accumulation chamber 11 that causes the pressure decrease at the outlet 5. In such a condition, if the user ceases to act on the brake lever, this condition causes the one-way valve 12 to open due to the lower pressure existing at inlet 4.

As noted above, according to a further embodiment of the invention, the electric actuator associated with the movable member of the fluid accumulator is a solenoid configured to push the movable member towards its starting position, thus counteracting a force generated by a hydraulic pressure tending to move the movable member in the direction of an increase in the volume of the accumulation chamber,
said electronic controller being configured to control the solenoid such that:
if the user starts braking, the solenoid is activated to keep the movable member of the accumulator in the position in which the accumulation chamber has a minimum volume,
when the ABS function is required, the force generated by the solenoid is progressively reduced, by reducing the current supplied to the solenoid, so that the movable member tends to move and create an increasing volume in the accumulator chamber in a progressive, substantially linear, manner, so as to cause said progressive and continuous, substantially linear, decrease of the pressure in the second hydraulic line, and
when the ABS function is no longer required, the force generated by the solenoid is progressively increased, by increasing the current supplied to the solenoid, in such a way as to cause said progressive and continuous, substantially linear, increase of the pressure in the second hydraulic line.

As is evident from the foregoing description, the ABS device according to the invention, in its various embodiments, ensures proper and reliable operation under all operating conditions, is relatively simple and low cost, and still ensures full operation of the braking system in the event of failure of the ABS device or lack of power supply. In addition, the device is configured to involve minimal energy expenditure when the ABS function needs to be activated.

Naturally, subject to the principle of the invention, the details of construction and forms of actuation may vary widely from what is described and illustrated by way of example only without departing from the scope of the present invention as defined in the appended claims.

1. ABS device for a hydraulic braking system of a bicycle, comprising:
an inlet, to be hydraulically connected to a master cylinder associated with a brake lever,
an outlet, to be hydraulically connected to an actuator cylinder associated with a brake device,
a first hydraulic line connecting said inlet to said outlet,
an electrically operated valve, which is normally open, interposed in the first hydraulic line,
a fluid accumulator, having an accumulation chamber defined by a movable member within a cavity, said movable member being normally in a starting position corresponding to a minimum volume of the accumulation chamber,
a second hydraulic line connecting the accumulation chamber to said outlet,
an electric actuator associated with the movable member of the fluid accumulator, and
an electronic controller configured to detect an activation condition in which an activation of an ABS function is required and which, in said activation condition, is further configured to switch said electrically operated valve to a closed condition and to enable a movement of the movable member of the fluid accumulator in a direction corresponding to an increase in the volume of the accumulation chamber, so as to cause a decrease in the pressure in the second hydraulic line,
wherein no electrically operated valve is interposed in said second hydraulic line, between the fluid accumulator and said outlet,
said electronic controller and said electric actuator of the movable member of the fluid accumulator configured in such a way that:
when the ABS function is activated, the electronic controller controls, through the electric actuator, a displacement of the movable member, so as to cause a progressive and continuous, substantially linear, decrease of the pressure in the second hydraulic line which in use communicates with the actuator cylinder of the brake device,
when the ABS function is no longer required, the return of the movable member of the fluid accumulator to the starting position is anyway positively controlled by the electronic controller, through said electric actuator, in such a way as to cause a progressive and continuous, substantially linear, increase of the pressure in the second hydraulic line which in use communicates with the actuator cylinder of the brake device.

2. An ABS device according to claim 1, wherein:
said electric actuator is an electric motor operatively connected to the movable member of the fluid accumulator by means of a mechanical transmission and configured to control a movement of the movable member either in a first direction corresponding to an increase in the volume of the accumulation chamber or in an opposite second direction corresponding to a decrease in the volume of the accumulation chamber, and
said electronic controller is configured for:
positively controlling, through said electric motor, a movement of the movable member of the fluid accumulator in said first direction, when a condition is detected in which an ABS function activation is required, so as to cause said progressive and continuous, substantially linear, decrease of the pressure in the second hydraulic line, and for
positively controlling, through said electric motor, a movement of the movable member of the fluid accumulator in said second direction, when the ABS function is no longer required, so as to cause said progressive and continuous, substantially linear, increase of the pressure in the second hydraulic line.

3. An ABS device according to claim 1, wherein the electric actuator associated with the movable member of the fluid accumulator is a solenoid configured to push the movable member towards the starting position, thus counteracting a force generated by a hydraulic pressure tending to move the movable member in the direction of an increase in the volume of the accumulation chamber,
said electronic controller being configured to control the solenoid such that:
if the user starts braking, the solenoid is activated to keep the movable member of the accumulator in the position in which the accumulation chamber has a minimum volume,
when the ABS function is required, the force generated by the solenoid is progressively reduced, by reducing the current supplied to the solenoid, so that the movable member tends to move and create an increasing volume in the accumulator chamber in a progressive, substantially linear, manner, so as to cause said progressive and continuous, substantially linear, decrease of the pressure in the second hydraulic line, and
when the ABS function is no longer required, the force generated by the solenoid is progressively increased, by increasing the current supplied to the solenoid, in such a way as to cause said progressive and continuous, substantially linear, increase of the pressure in the second hydraulic line.

4. An ABS device according to claim 1, characterized in wherein the second hydraulic line has a downstream portion connecting the accumulation chamber with said outlet, and an upstream portion connecting the accumulation chamber with said inlet with the interposition of a one-way valve comprising an on/off element elastically biased to a closed position so as to allow fluid flow only from said downstream portion of the second hydraulic line to said upstream portion of the second hydraulic line.

5. An ABS device according to claim 4, wherein said movable member is configured to maintain the on/off element of said one-way valve in an open condition when said movable member is in its starting position.

6. An ABS device according to claim 4, wherein said movable member is configured to never interact with the on/off element of said one-way valve, so that said on/off element opens only when the pressure on the inlet side falls below the pressure on the outlet side by an extent sufficient to overcome the spring action tending to keep the on/off element closed.

7. An ABS device according to claim 4, further comprising a pressure sensor associated with said downstream portion of the second hydraulic line.

8. An ABS device according to claim 1, wherein said second hydraulic line comprises only a line connecting the accumulation chamber of the fluid accumulator to said outlet, wherein no connection is provided between the accumulation chamber of the fluid accumulator with the inlet, and
a pressure sensor configured to sense the pressure at the inlet of the ABS device is provided, or:
a one-way valve is provided in the first hydraulic line, integrated into said electrically operated valve, such that when the electrically operated valve is closed, said one-way valve still enables a flow of fluid in the direction of said inlet through the electrically operated valve if the pressure at the inlet falls below the pressure at the outlet by a differential greater than a threshold.

9. An ABS device according to claim 2, wherein said mechanical transmission connecting the electric motor to the movable member of the fluid accumulator is a gear transmission connecting an outlet shaft of the electric motor with a rack rigidly connected to said movable member of the fluid accumulator.

10. An ABS device according to claim 1, wherein said electrically operated valve and said fluid accumulator are arranged within the same body, in which are also formed said inlet, said outlet, said first hydraulic line and said second hydraulic line, and
said first hydraulic line includes:
a first elongated cavity formed in said body from said inlet,
a second elongated cavity formed in said body and intersecting the first cavity in a direction orthogonal to the direction of said first cavity, and
a third elongated cavity formed in said body, intersecting said second cavity according to a direction parallel to and spaced apart from the direction of the first cavity and terminating in said outlet,
and the electrically operated valve has a stem or an on/off element movable within said second cavity between an open position, in which the first cavity communicates with the third cavity, and a closed position, in which this communication is interrupted.

11. An ABS device according to claim 10, wherein said second hydraulic line comprises a fourth elongated cavity formed in said body in a direction parallel to and spaced apart from the direction of said second cavity and flowing into said third cavity, and said accumulator chamber is defined by a fifth elongated cavity orthogonal to said fourth cavity and flowing into said fourth cavity, said movable member of the fluid accumulator being a stem slidable within said fifth cavity.

12. An ABS device according to claim 11, wherein the fifth cavity is arranged aligned on an extension of said first cavity on a side of said fourth cavity opposite that of said first cavity,
a crossing area between the fourth cavity and the fifth cavity communicates with said first cavity via a passageway,
at one end of said first cavity on the side opposite to the inlet is arranged a one-way valve that allows a flow of fluid only from said crossing zone to said first cavity, and
said one-way valve includes an on/off element biased by a spring to a closed position in which it obstructs said communication passage.

13. An ABS device according to claim 12, wherein the movable member of the fluid accumulator has a front nose which engages said on/off element of said one-way valve, holding it in an open position when the movable member is in its starting position.

14. A method for controlling a hydraulic braking system of a cycle or motorcycle, particularly for a bicycle, wherein said system includes an ABS device comprising:
an inlet, to be hydraulically connected to a master cylinder associated with a brake lever,
an outlet, to be hydraulically connected to an actuator cylinder associated with a brake device,
a first hydraulic line connecting said inlet to said outlet,
an electrically operated valve, which is normally open, interposed in the first hydraulic line,
a fluid accumulator, having an accumulation chamber defined by a movable member within a cavity, said movable member being normally in a starting position corresponding to a minimum volume of the accumulation chamber,
a second hydraulic line connecting the accumulation chamber to said outlet,
an electric actuator associated with the movable member of the fluid accumulator,
wherein the method comprises detecting, through an electronic controller, a condition in which an activation of an ABS function is required, and, in this condition, switching said electrically operated valve to a closed condition and enabling a movement of the movable member of the fluid accumulator in a direction corresponding to an increase in the volume of the accumulation chamber, so as to cause a decrease of the pressure in the second hydraulic line,
wherein in said second hydraulic line, between the fluid accumulator and said outlet, no electrically operated valve is interposed,
said method comprising
when the ABS function is activated, the electronic controller controlling, through the electric actuator, a displacement of the movable member in such a way as to cause a progressive and continuous, substantially linear, decrease of the pressure in the second hydraulic line that communicates with the actuator cylinder of the brake device,
when the ABS function is no longer required, the electronic controller positively controlling, through the electric actuator, the return of the movable member of the fluid accumulator to the starting position, so as to cause a progressive and continuous, substantially linear, increase of the pressure in the second hydraulic line that communicates with the actuating cylinder of the brake device.

15. A method according to claim 14, wherein:
said electric actuator is an electric motor operatively connected to the movable member of the fluid accumulator by means of a mechanical transmission and configured to control a movement of the movable member both in a first direction corresponding to an increase in the volume of the accumulation chamber and in a second and opposite direction corresponding to a decrease in the volume of the accumulation chamber, and in that:
said electronic controller positively controls, through said electric motor, a movement of the movable member of the fluid accumulator in said first direction, when a condition is detected in which an activation of an ABS function is required, so as to cause said progressive and continuous, substantially linear, decrease of the pressure in the second hydraulic line, and
said electronic controller positively controls, through said electric motor, a movement of the movable member of the fluid accumulator in said second direction, when the ABS function is no longer required, so as to cause said progressive and continuous, substantially linear, increase of the pressure in the second hydraulic line.

16. A method according to claim 14, wherein the electric actuator associated with the movable member of the fluid accumulator is a solenoid configured to push the movable member toward the starting position, thus counteracting a force generated by a hydraulic pressure tending to move the movable member in the direction of an increase in the volume of the accumulator chamber, and:
if the user starts braking, the electronic controller activates the solenoid to keep the movable member of the accumulator in the position in which the accumulator chamber has a minimum volume,
when the ABS function is required, the force generated by the solenoid is progressively reduced, by decreasing the current supplied to the solenoid, so that the movable member tends to move and create an increasing volume of the accumulator chamber in a progressive, substantially linear manner, so as to cause said progressive and continuous, substantially linear, decrease of the pressure in the second hydraulic line, and
when the ABS function is no longer required, the force generated by the solenoid is progressively increased, by increasing the current supplied to the solenoid, so as to cause said progressive and continuous, substantially linear, increase of the pressure in the second hydraulic line.
